(19) United States
(12) Patent Application Publication
(10) Pub. No.: US 2011/0087371 A1
(43) Pub. Date: Apr. 14, 2011

(54) RESPONSIVE CONTROL METHOD AND SYSTEM FOR A TELEPRESENCE ROBOT

(76) Inventors: Roy Benjamin Sandberg, San Francisco, CA (US); Dan Ron Sandberg, Stockholm (SE)

(21) Appl. No.: 12/737,053

(22) PCT Filed: Jun. 4, 2009
(86) PCT No.: PCT/US09/03404

§ 371 Date: Dec. 3, 2010

Related U.S. Application Data
(60) Provisional application No. 61/131,044, filed on Jun. 5, 2008.

(51) Int. Cl. G06F 19/00; G05D 1/00

(52) U.S. Cl. 700/245; 701/2

(57) ABSTRACT

A method and apparatus for controlling a telepresence robot.

### BACKGROUND OF THE INVENTION

(1) Field of Invention

The present invention is related to the field of telepresence robotics, more specifically, the invention is an improved method for controlling a telepresence robot using a pointing device or joystick.

(2) Related Art

Telepresence robots have been used for military and commercial purposes for some time. Typically, these devices are controlling using a joystick, or some user interface based on a GUI with user controlled buttons that are selected using a pointing device such as a mouse, trackball or touch pad.

While these user interface mechanisms enable some degree of control over the distant robot, they are often plagued by problems concerning latency of the Internet link, steep learning curves, and difficulty of use.

### SUMMARY OF THE INVENTION

The present invention is related to the field of telepresence robotics, more specifically, the invention is method for controlling a telepresence robot, with a conventional pointing device such as a mouse, trackball, or touchpad. In an alternative embodiment of the invention, a method for controlling a telepresence robot with a joystick is described. This patent application incorporates by reference copending application Ser. No. 11/223,675 (Sandberg). Matter essential to the understanding of the present application is contained therein.

### Optimal Curves Based on Screen Location to Maintain Controllability

As disclosed in co-pending application 60/815,897 (“Method and apparatus for robotic path planning, selection, and visualization”), a telepresence robot may be controlled by controlling a path line that has been superimposed over the video image displayed on the client application and sent by the remotely located robot. This co-pending application is incorporated by reference herein.

To review, a robot can be made to turn by defining a clothoid spiral curve that represents a series of points along the floor. A clothoid spiral is a class of spiral that represents continuously changing turn rate or radius. A visual representation of this curve is then superimposed on the screen. The end point of the curve is selected to match the current location of the pointing device (mouse, etc.), such that the robot is always moving along the curve as defined by the pointing device. A continuously changing turn radius is necessary to avoid discontinuities in motion of the robot.

Herein, an improvement of this technique is described. Specifically, by selecting an appropriate maximum turn radius for the path line depending on the desired final movement location, the controllability of the robot can be improved.

It should be clear that small radius turns, being sharper turns than large radius turns, result in faster change of direction when speed is held constant. This is advantageous when the user desires to turn quickly, but makes straight line movement very challenging because the user is often struggling to compensate for overshoot that results from the rapid turns. When the user wants the robot to move in a straight line (for example, down a hallway), very large radius turns are ideal. Note that a perfectly straight line would not allow the user to correct for small positional errors that often occur as the robot moves forward. Finally, intermediate-radius turns are desirably when a sweeping turn is needed, for example, when a robot makes a 90 degree turn from one hallway to an intersecting hallway. A very sharp turn would not be appropriate in this case unless the robot was traveling very slowly, since a very fast change in direction might cause the robot to lose traction and spin out of control. Thus is can be seen that different turning radius turns are appropriate in different situations.

In the preferred embodiment of the invention, the largest possible turn radius that allows the robot to reach a selection location is used. Via this technique, the robot turns no faster than is necessary to reach a point, but is always guaranteed to move to the selected destination. This technique also allows an experienced user to intentionally select sharp-radius turns by selecting particular destinations.

The following algorithm will select the largest possible turn radius for a particular destination:

abs(x)>=abs(y):radius=y

abs(x)<abs(y):radius=(x²+y²)/2*abs(x)

where the robot is assumed to be located at (0,0) and (x,y) represents the desired location.

Note that as discussed in 60/815,897 (“Method and apparatus for robotic path planning, selection, and visualization”), a means of transitioning from one turn radius to another is required to avoid discontinuous wheel velocities. It is assumed that an underlying software layer generates the clothoid spiral that transitions from one radius to another, but the above algorithm is used to select the steady-state radius.

There are two special case radii that should be discussed.

An infinite radius turn is equivalent to a straight line. To simply the algorithm (and eliminate the need for a special case), a straight line can be modeled as a large radius turn, where the radius is large enough to appear straight. In the preferred embodiment, a radius of 1,000,000 meters is used to approximate a straight line.

A zero radius turn may be considered a request for the robot to rotate about it's center. This is effectively a request to rotate in place. To simplify the algorithm (and eliminate the need for a special case), a request to rotate in place can be modeled as an extremely small radius turn, where the radius is small enough to appear to be a purely rotational movement. In the preferred embodiment, a radius of 0.00001 meters is used to approximate an in-place rotation.

### Backwards Movement

It is often desirable to be able to move a telepresence robot backwards, away from the direction that the telepresence robot camera is facing. This is useful to back away from obstacles before selecting a new path to move along.

When using a joystick, one may swivel the joystick towards oneself in order to effect a backwards move. This joystick movement can be integrated with the joystick-based latency correction embodiment of the invention, as described below.

When superimposing a move path onto the video screen, a backwards move may be initiating by tilting the camera such that it affords a view of the terrain behind the robot. However, much as one might take a step backwards without looking behind one's self, it is often desirable to back up a telepresence robot without “looking.” A means of accomplishing this is now described. By designing the client application such that an empty zone exists below the video image on the client application, it is possible for a user to select a backwards-facing movement path. The user will not be able to view the distant location where this movement path terminates, but the overall direction and shape of the path can be seen, and the movement of the robot can be visualized by watching the forward view of the world recede away from the camera. Furthermore, the readouts from one or more backward-facing distance sensors can be superimposed on this empty zone, so that some sense of obstacles located behind the telepresence robot can be obtained by the user.

When selecting a robot movement location using the superimposed curve technique previously discussed, an ambiguity exists involving backwards motion. When moving forward it is clear that any location in the positive Y Cartesian plane represents forward motion. However, when a robot is already moving forward, it is not necessarily obvious that a location in the negative Y Cartesian plane should represent a backwards move. Conceivably, the user may be selecting a region in the negative Y Cartesian plane out of a desire to make a greater than 90 degree turn to the left or right. To avoid this ambiguity, the preferred embodiment of this invention does not allow forward-direction turns greater than 90 degrees. Upon stopping, a backwards movement turn may be selected. Turns greater than 90 degrees are treated as a request for a 90 degree turn, and the robot does not slow down until the turn angle exceeds some greater turn angle. In the preferred embodiment the turn angle where the robot begins to slow is 120 degrees. In another embodiment of this invention, any negative Y Cartesian plane coordinate is honored as a request to move backwards only if the negative Y Cartesian plane was first selected using a mouse click in the negative Y Cartesian plane; moving the mouse pointer to the negative Y Cartesian plane while the mouse button is already pressed will not be honored until the turn angle exceeds the threshold just discussed.

### Joystick-Based Latency Correction—Overview

As of this writing, few personal computers are equipped with joysticks. However, some subset of users will prefer to control a telepresence robot using a joystick, despite the advantages of the aforementioned path-based control technique. A problem with joystick-based control is handling the effects of latency on the controllability of the telepresence robot. Latency injects lag between the time a joystick command is sent and the time the robot's response to the joystick command can be visualized by the user. This tends to result in over-steering of the robot, which makes the robot difficult to control, particularly at higher movement speeds and/or time delays.

This embodiment of the invention describes a method for reducing the latency perceived by the user such that a telepresence robot can be joystick-controlled even at higher speeds and latencies. By simulating the motion of the robot locally, such that the user perceives that the robot is nearly perfectly responsive, the problem of over-steering can be minimized.

In a non-holonomic robot, movement of the robot can be modeled as having both a fore-aft translational component, and a rotational component. Various combinations of rotation and translation can approximate any movement of a non-holonomic robot.

Particularly for small movements, left or right translations of the video image can be used to simulate rotation of the remote telepresence robot.

Similarly, for small fore-aft movements zooming the video image in or out can simulate translation of the robot. Care must be taken to zoom in or out centered about a point invariant to the fore-aft direction of movement of the robot, rather than the center of the camera's field of view, which is not generally the same location. The point invariant to motion in the fore-aft direction is a point along the horizon at the end of a ray representing the instantaneously movement direction of the robot.

When moving in a constant radius turn, which consists of both a translational and rotational component, modeling both the translation and rotation as discussed above results in an error relative to the actual move. This is because a constant radius turn involves some lateral (left-right) translation as well as a fore-aft translation and a rotational component. It is not possible to translate or zoom in a manner that approximates a lateral move, because during a lateral move, objects closer to the camera are perceived as translating farther than objects far from the camera.

### Characterization of Lateral Movement Errors

When simulating a constant radius turn move, we focus on eliminating any error in the rotation angle, since errors in the perceived rotation angle are the dominant cause of over-steering. The lateral translation error resulting from a simulation of a constant radius move by zooming and translating a video image can be calculated as follow.

The lateral movement from a pure arc motion (constant radius turn) is:

r*(1−cos(theta))

The lateral movement from a rotation by theta, and then a straight line movement equal in distance in y to the pure arc motion is:

tan(theta)*(r*(sin(theta)))

The difference between these two is therefore the lateral error:

lateral_error=tan(theta)*(r*(sin(theta)))−r*(1−cos(theta))

where r is the turn radius and theta is the turn angle. It can be seen that for small values of theta, the lateral error is small. Therefore, for small values of theta, we can realistically approximate the remote camera's view by manipulating the local image.

The local client, using the current desired movement location, and the last received video frame, must calculate the correct zoom and left-right translation of the image to approximate the current location of the robot. It is still necessary to send the desired movement command to the remotely located robot, and this command should be sent as soon as possible to reduce latency to the greatest possible degree.

Calculating the Desired Movement-Location Using a Joystick-Based Input

A joystick can either feed in an input value that represents acceleration or velocity. In the preferred embodiment, the joystick input (distance from center-point) is interpreted as a velocity, because this results in easier control by the user; acceleration is likely to result in overshoot, because an equivalent deceleration must also be accounted for by the user during any move.

In the fore-aft direction of motion, the joystick input (assumed to be a positive or negative number, depending on whether the stick is facing away from or towards the user) is treated as a value proportional to the desired velocity of the fore/aft motion. In the preferred embodiment, valid velocities range from −1.2 m/s to +1.2 m/s, although other ranges may also be used.

In the left-right direction of motion, the joystick input (assumed to be a positive or negative number depending on the stick facing left or right) is treated as a value proportional to the desired angular velocity, (i.e, a rate of rotation). In the preferred embodiment, valid angular velocities range from −0.5 rev/s to +0.5 rev/s, although other ranges may also be used.

A combination of fore-aft and left-right joystick inputs is treated as a request to move in a constant radius turn. Given a movement velocity of Y, and an angular velocity of Theta, the turn radius is (Y/Theta), assuming that angular velocity is expressed in radians. This turn may be clockwise or counterclockwise, depending on the sign of the angular velocity.

In an alternative embodiment of the invention, the fore-aft and left-right velocity and angular velocity are treated as steady-state maximum goal values that are reached after the robot accelerates or decelerates at a defined rate. This bounds the rate of change of robot movement, which keeps the simulated position and the actual position of the robot closer together, minimizing the lateral error.

Given an velocity and an angular velocity, both optionally bounded by a maximal acceleration value, an (x,y) position in a Cartesian plane can be calculated. This can be accomplished by beginning at x=0, y=0, and theta=0, and updating the position each time a new joystick input is captured. Assuming a high rate of joystick input captures, we can divide the velocity by the number of input captures per second and add that value to x and y, accounting for the current direction that the robot is facing (i.e., we use trigonometry to add the correct values to x and y based on theta). We can calculate the theta position by dividing the angular velocity by the number of input captures per second and adding that value to the current theta location. Using this method we incrementally update the current x, y, and theta based on new joystick values as they are captured. The current x, y, and theta is then sent to the remote robot as the new goal location. As discussed in 60/815,897 (“Method and apparatus for robotic path planning, selection, and visualization”) a clothoid spiral can be generated from the current robot position to the desired robot position using this information.

### Calculating Zoom and Left-Right Translation Using the Desired Movement Location

Now we must calculate the correct zoom and left-right translation amounts in order to compensate for the latency of the telepresence robot system.

Each video frame received from the robot is assumed to have information embedded in or associated with the video frame that can be used to calculate the position of the robot at the time the video frame was captured. Using this information, and the current x, y, and theta values as calculated above, we can compensate for latency in the system.

In particular, the location of the robot (x, y, and theta) at the time that the video frame was captured by the robot may be embedded within the video frame.

The client generates its own x,y, and theta values as discussed in the previous section. The client should store the x, y, and theta values with an associated time stamp. For past times, it would then be possible to consult the stored values and determine the x, y, and theta position that the client generated at that time. Through interpolation, an estimate of location could be made for any past time value, or, conversely, given a position, a time stamp could be returned.

Because the x, y, and theta locations generated by the client are actually used as coordinates for robot motion, any x, y, and theta embedded in a video frame and sent by the robot to the client should map to an equivalent x, y, and theta value previously generated by the client. Because a time stamp is associated with each previously stored location value at the client, it is possible to use interpolation to arrive at the time stamp at which a particular (video-embedded) location was generated by the client. The age of this time stamp represents the latency the system experienced at the time the robot sent the video frame.

The difference between the location reported by the robot as an embedded location, and the present location as calculated by the client represents the error by which we must correct the video image to account for latency. We pan the video frame left or right by the difference in theta values, and we zoom in or out by a zoom level that approximates the difference between y values.

Specifically, when zooming, we center the zoom action around the point that remains stationary when the robot moves forward. This is the point on the video image that is parallel to the direction of motion. Furthermore, we want the user to perceive that the robot has moved forward or backward on the floor by an amount equal to the y value we are correcting by. Therefore, we are looking for the point along the Y-axis of the video image that is equal in distance from the bottom of the video frame to the distance we want to correct by. When the robot is moving forward, this distance is above the bottom of the frame, and we must zoom in. When the robot is moving backwards, this distance is below the bottom of the frame, and we must zoom out and display black space in the region that we have no video data for.

We assume that the area directly in front of the robot is the floor, and therefore, because we know the distance from the camera to the floor, and the angle of the camera, we can calculate convert between a movement distance and a position in the video data. We can therefore calculate the distance to zoom using simple trigonometry.

### Improvements Offered Through Use of a 3D Camera

In an alternative embodiment of the invention, a 3D camera is used to collect visual data at the robot's location. A 3D camera collects range information, such that pixel data in the camera's field of view has a distance information associated with it. This offers a number of improvements to the present invention.

Latency correction may be extended to work for holonomic motion. Because the distance of each pixel is known, it is possible to shift all pixels to the left or right by a common amount while correctly accounting for the effects of perspective. In other words, nearby pixels will appear to shift to the left or right more than distant pixels.

Furthermore, even for non-holonomic movement, a more accurate simulation of the future position of the robot may be calculated. This is because distance information allows the video image to corrected for x-axis offsets that occur during a constant radius turn. In effect, the x-axis offset that occurs is equivalent to holonomic motion to the left or right.

Combining on-Screen Curves with Localized Latency Compensation

The joystick-based latency compensation can be modified to be used with the on-screen curve technique that has been previously discussed. In this embodiment, a mouse or other pointing device is used to locally (at the client) create a curved line that represents the path along the ground that a distant telepresence robot should follow. Information representing this path is sent to the distant telepresence robot. As discussed in co-pending application 61/011,133 (“Low latency navigation for visual mapping for a telepresence robot”), the distant robot may correct for the effects of latency by modifying this path to represent a more accurate approximate of the robots true location.

Additionally, it is possible to locally model the location of the robot, such that the local user perceives that the robot is responding instantaneously to the move request represented by the curved path line. This is done in a similar manner to the technique discussed in the joystick-based latency compensation technique, except that local client simulates the motion that the robot will undergo as it moves along the curved path line. Calculating zoom and left-right translation is done as before, except that local movement is restricted to movement along the aforementioned path line.

The location represented by the local curve line thus accounts for the anticipated position of the robot at some future time.

Via this technique, the local client more accurately models the state of the remote telepresence device, so that the local user does not perceive any lag when controlling the robot.

However, the distant telepresence robot may differ from the anticipated position for various reasons. For example, the distant robot may encounter an obstacle that forces it to locally alter its original trajectory or velocity. The remote robot may compensate for the error between the predicted position and the actual position by correcting for this difference when it receives the movement command location. This is done in the manner disclosed in co-pending application 61/011,133 (“Low latency navigation for visual mapping for a telepresence robot”). This co-pending application is incorporated by reference herein.

### DETAILED DESCRIPTION OF THE DRAWINGS

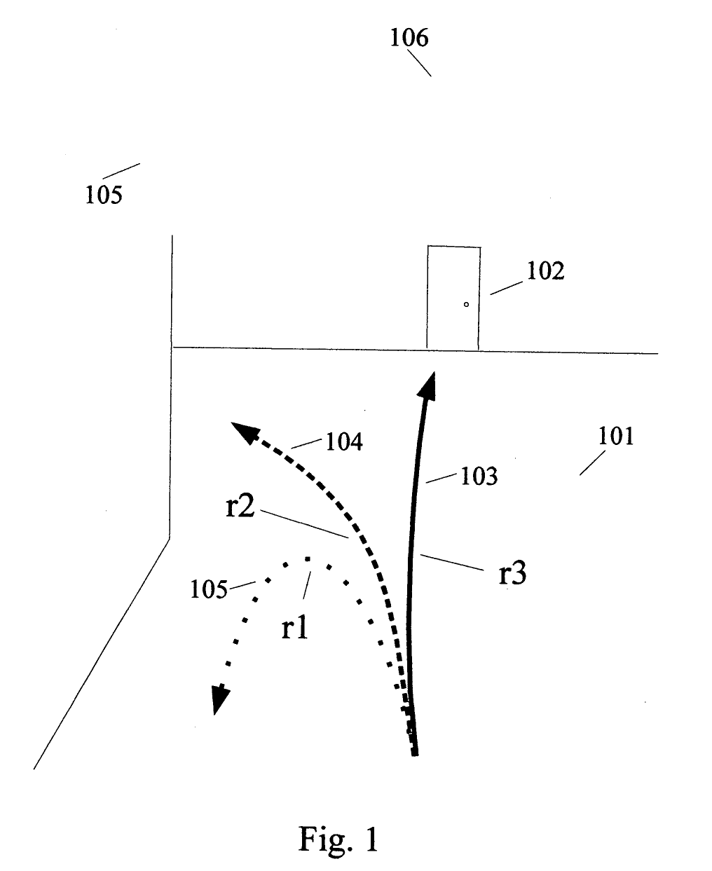

FIG. 1 is a exemplary embodiment of the invention showing a series of optimal curves superimposed on a video frame.

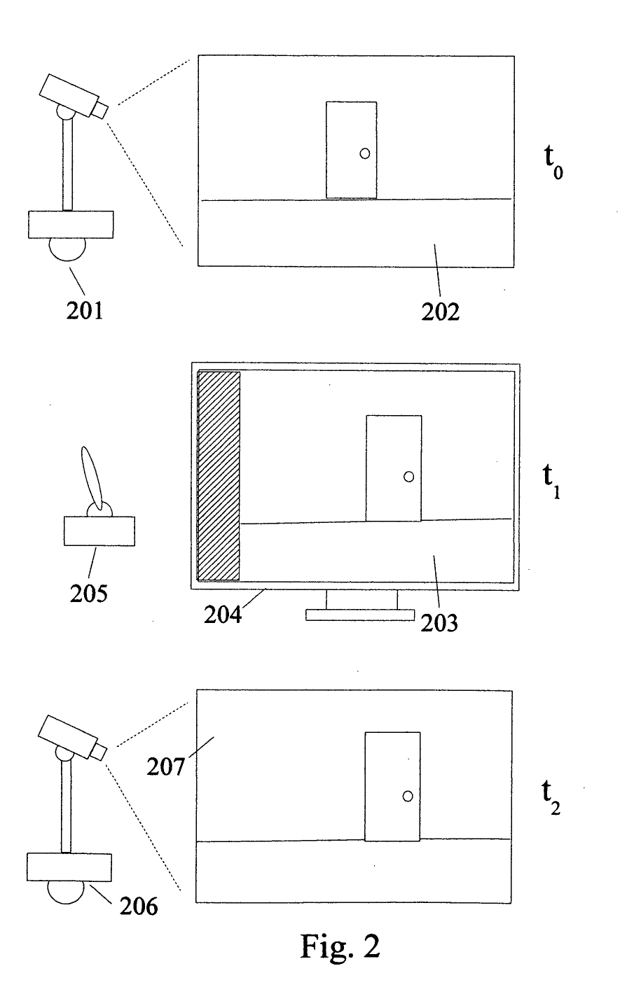

FIG. 2 is a chart showing the interaction between components for the joystick-based control aspect of the invention.

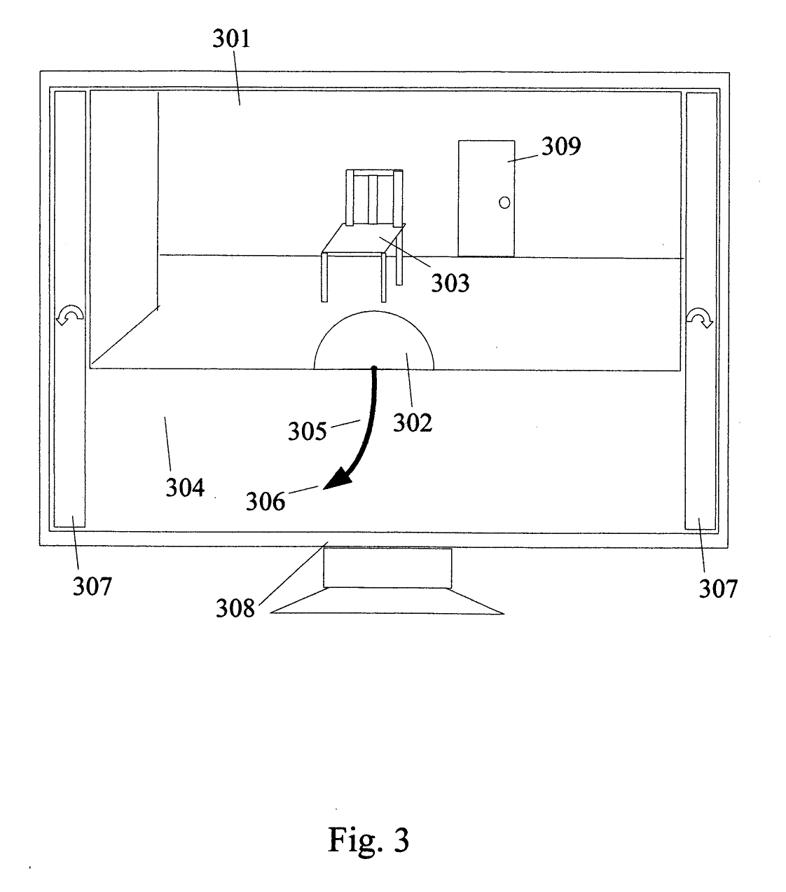

FIG. 3 is a diagram of a user interface used to allow backwards motion.

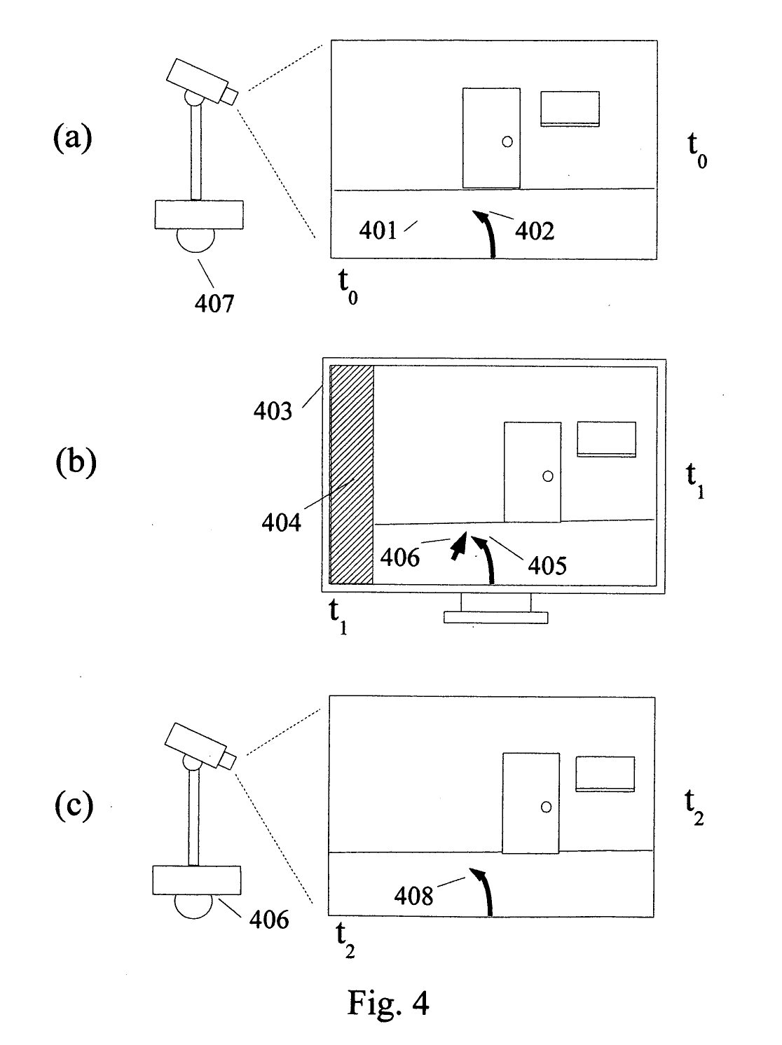

FIG. 4 is a flow chart of the latency compensation algorithm for the superimposed curve latency compensation scheme.

### DETAILED DESCRIPTION OF THE INVENTION

The present invention is a method and apparatus for controlling a telepresence robot.

FIG. 1 is a exemplary embodiment of the invention showing a series of optimal curves superimposed on a video frame capturing a video of an indoor environment 101 with a door 102 in the distance. A series of three curves are shown. The solid line 103 represents a large radius turn, such as would be used when traveled at high speed down a hallway. The dashed line 104 represents a medium radius turn, as would be used when turning from one hallway to another. The dotted line 105 represents a small radius turn, as would be used when making a U-turn. All three turns conform to a formula, wherein the nominal radius of the turn is equal to:

abs(x)>=abs(y):radius=y

abs(x)<abs(y):radius=(x²+y²)/2*abs(x)

where the robot is assumed to be located at (0,0) and (x,y) represents the desired location.

FIG. 2 is a chart showing the interaction between components for the joystick-based control aspect of the invention. A telepresence robot 201 takes a picture of its environment 202 at time t₀. At t₁, the picture 203, with embedded location information, is received at the client, and displayed on the monitor 204. The picture is shifted and zoomed to compensate for local predicted movement of the distant telepresence robot based on input previously received from the joystick. New joystick input 205 is used to generate a new movement command. At t₂, the new movement command is received and processed at the telepresence robot 206, resulting in a new picture of the environment 207. This process is repeated, enabling the telepresence robot to be controlled with a reduced perception of latency.

FIG. 3 is a diagram of a client user interface as seen on a monitor 308, used to allow backwards motion. The user interface shows the remote video data 301 received from the distant telepresence robot. The base of the front half of the distant telepresence robot 302 is visible along the bottom of the video image. A chair 303 can be seen blocking the path forward. The robot is shown being backed away from the chair, such that it will face the door 309 upon completion of the move. Below the video data is an empty space 304. A path line 305 is shown extending into this space, and therefore extending behind the centerline of the robot. The path line ends at a point behind the robot 306, and represents a movement destination behind the robot. Via this means, a telepresence robot can be commanded to move backwards, to a location not visible on the screen, using a standard computer pointing device. Note that on-screen buttons 307 are used to rotate the robot in place left or right.

FIG. 4 is a flow chart of the latency compensation algorithm for the superimposed curve latency compensation scheme. At time t=0 a video image 401 is sent (along with embedded distance information—the current x, y, and theta values based on dead reckoning) from a distant telepresence robot to a client application. It can be seen that at time the telepresence robot is moving towards the left edge of a door 402.

At time t=1, the video image, being processed and viewed at the client, 403, is translated and shifted, creating an empty space on the monitor, 404 to account for the difference in position between the transmitted image and the predicted location of the robot at the client. This predicted location is determined by locally simulating motion of the telepresence robot based on estimated velocity and acceleration values for the robot wheels (or tracks, etc.). Acceleration and velocity values are calculated based on the last acceleration and velocity values sent from the robot. These old acceleration and velocity values are then modified by a delta that represents the change in acceleration and velocity that would result if the current goal acceleration and velocity (as specified by the last movement command generated at the client) are successfully executed at the robot. A local (i.e., client-side) estimation of position is generated by calculating the estimated future position of the robot based on these estimated future acceleration and velocity values.

The image is translated (shifted) right or left to compensate for rotation of the robot clockwise or counterclockwise. The image is zoomed in or out to compensate for forward or backward motion of the robot. A path line 405 is then displayed on this location-corrected video image, and a user command representing the end-point of the path line is sent to the distant telepresence robot. The end-point of the path line is thus the predicted end-point based on estimated future acceleration and velocity values.

At time t=2, the user command is received by the distant telepresence robot 406. The user command location movement path 408 is then recalculated at the robot to account for inaccuracies between the predicted location and the actual measured location at the telepresence robot. For example, although the user command location may specify a target destination of (x=10, y=10), the true current position of the robot 406 may be different than expected (due, for example, to the latency over the communication link), and so the actual movement path 408 from the robots true position to the desired target destination may be different than the one calculated at the client 405.

### ADVANTAGES

What has been described is a method and apparatus for improving the controllability of a remotely operated robot through the selection of an appropriate turning radius, and via reducing the perception of latency when operating the telepresence robot.

This is useful for many purposes, including improved control over remotely operated ground vehicles, and greater responsiveness of robots used to project one's presence to a distant location.

While certain exemplary embodiments have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

What is claimed:

1. A method for calculating a remote vehicle path, comprising the steps of:
moving a remote vehicle along a trajectory;
accepting an instantaneous target destination as an input to a computational device;
calculating a path to the instantaneous target destination, such that the path has a turn radius that varies based on the instantaneous target destination; and
modifying a trajectory of the moving remote vehicle such that it substantially comports with the calculated path to the instantaneous target destination.

2. The method of claim 1 wherein the turn radius varies according to the Cartesian distance to the instantaneous target destination based on the following formula:
abs(x)>=abs(y):radius=y
abs(x)<abs(y):radius=(x²+y²)/2*abs(x)

2. The method of claim 1, further comprising displaying the calculated path to the instantaneous target location as a curve superimposed on the video image of the remote location such that the superimposed curve substantially displays the predicted path of the vehicle along the floor as shown in the video image.

3. The method of claim 1, further comprising the step of accepting input from a joystick.

4. The method of claim 1, further comprising the step of accepting input from a computer pointing device

5. A method for compensating for a remote vehicle control latency, comprising the steps of
capturing a video image from a remote mobile robot camera;
associating a current robot position with the video image;
transmitting the video image and the current robot position to a mobile robot control station;
calculating a predicted robot position at the mobile robot control station;
calculating a translation amount based on the current robot position and the predicted robot position;
translating the video image by the calculated translation amount; and
displaying the translated video image on display at the robot control station.

6. The method of step 5, further comprising the steps of calculating a zoom amount based on the current robot position and the predicted robot position, and zooming the video image by the calculated zoom amount.

7. The method of step 5, further comprising the steps of:
transmitting the predicted robot position to a remote mobile robot and compensating for inaccuracies in a predicted trajectory of the robot by recalculating a movement path at the robot.

8. A method for enabling backwards motion of a remote vehicle, comprising the steps of:
displaying a video image of a view taken by a remote mobile robotic camera on a video display;
selecting a region of the video display beneath the video image; and
generating a command to move to the selected region.
